(19) United States
(12) Patent Application Publication
(10) Pub. No.: US 2012/0287506 A1
(43) Pub. Date: Nov. 15, 2012

(54) COLOR FILTER SUBSTRATE CAPABLE OF POLARIZING AND MANUFACTURING METHOD THEREOF

(75) Inventors: Qi YAO, Beijing (CN); Zhanfeng CAO, Beijing (CN); Tianming DAI, Beijing (CN); Feng ZHANG, Beijing (CN); Chuanxiang XU, Beijing (CN)

(73) Assignee: BOE TECHNOLOGY GROUP CO., LTD., Beijing (CN)

(21) Appl. No.: 13/469,644

(22) Filed: May 11, 2012

(30) Foreign Application Priority Data
May 13, 2011 (CN) 201110124682.3

(51) Int. Cl. G02B 5/30

(52) U.S. Cl. 359/491.01

(57) ABSTRACT

The present disclosure relates to a field of liquid crystal display. A color filter substrate capable of polarizing and a manufacturing method thereof are disclosed. The manufacturing method of a color filter substrate comprises: step 1, forming an intermediate layer containing conductor on a substrate; step 2, forming a photoresist layer on the intermediate layer; step 3, forming the photoresist layer into a photoresist pattern with a grating pattern of nanometer size; and step 4, using this photoresist pattern with a grating pattern of nanometer size to etch the underlying intermediate layer to form the intermediate layer into a black matrix and a polarizing structure having grating patterns.

### BACKGROUND

Embodiments of the present disclosure relate to a liquid crystal display, and in particular, to a color filter substrate and a method of manufacturing a color filter substrate.

Thin film transistor liquid crystal displays (TFT-LCDs) have become the mainstream of flat panel displays, and have the advantages of low power consumption, relatively low cost, and substantially no radiation. The display principle of the TFT-LCDs is that, by way of the dielectric anisotropic and conductive anisotropic properties of liquid crystal molecules, the orientation state of liquid crystal molecules can be changed under an applied external electrical field, which in turn leads to the change of the light transmittance.

A TFT-LCD panel is made by assembling a color filter substrate and an array substrate facing each other. As shown in FIG. 1, it is a sectional view of a conventional color filter substrate. During the producing process of a TFT-LCD, the following method is often used to manufacture the conventional color filter substrate. First, a metal layer for manufacturing a black matrix (BM) 2 is formed on a glass substrate 1; a layer of photoresist (PR) is coated on the metal layer, the photoresist is exposed to obtain a photoresist pattern layer, and then the photoresist pattern layer is used as a mask for etching the metal layer to obtain a black matrix 2; next, a color filter layer 4, an overcoat 5, a transparent common electrode 6 and spacers 7 are formed in this order on the above structure. The color filter substrate formed with the above processes does not have the capability of polarizing, and a polarizer film is additionally attached on the external side of the glass substrate. Such a method of manufacturing a color filter substrate is complicate and time consuming and incurs high human and material costs.

### SUMMARY

One of the technical problem to be solved in the disclosure is about how to simplify the manufacturing steps of a color filter substrate and reduce the manufacturing costs.

One aspect of the disclosure provides a manufacturing method of a color filter substrate comprising: step 1, forming an intermediate layer containing conductor on a substrate; step 2, forming a photoresist layer on the intermediate layer; step 3, forming the photoresist layer into a photoresist pattern with a grating pattern of nanometer size; and step 4, using the photoresist pattern with a grating pattern of nanometer size to etch the underlying intermediate layer to form the intermediate layer into a black matrix and a polarizing structure having grating patterns.

Another aspect of the disclosure also provides a color filter substrate capable of polarizing comprising a substrate, a black matrix formed on the substrate. The substrate is formed with a polarizing structure thereon in the same layer with the black matrix. The polarizing structure comprises a plurality of regions (units) spaced from each other and has parallel grating pattern of nanometer size.

Further scope of applicability of the disclosed technology will become apparent from the detailed description given hereinafter. However, it should be understood that the detailed description and specific examples, while indicating preferred embodiments of the disclosed technology, are given by way of illustration only, since various changes and modifications within the spirit and scope of the disclosed technology will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a structure schematic view of color filter substrate in the prior art.

FIG. 2 is a cross sectional schematic view of a color filter substrate capable of polarizing in the embodiment of the disclosure.

FIG. 3 is a top view of a black matrix and a polarizing structure in the embodiment of the disclosure.

### DETAILED DESCRIPTION

The implementation of the disclosure will be described in detail below in conjunction with the drawings. The following embodiments are for purpose of illustrating the disclosure, but not limiting the scope of the disclosure.

A manufacturing method of a color filter substrate of the embodiment of the disclosure comprises the following steps.

Step 1, forming an intermediate layer for forming a black matrix on a base substrate.

The base substrate may be a glass substrate, a quartz substrate or a plastic substrate. The intermediate layer in this embodiment may be a metal layer, for example, an aluminum, chrome, gold or silver layer. The intermediate layer may also be a resin layer containing conductive materials, which may be metal wires, such as silver wires, aluminum wires and the like of nanometer size, or additives such as metal powders, such that the resultant polarizing structure has a certain electromagnetism characteristics. The intermediate layer is used to form the black matrix (BM) in subsequent steps.

Step 2, forming a photoresist layer on the intermediate layer.

Step 3, forming a photoresist pattern with a grating pattern of nanometer size with the photoresist layer.

For example, it is applicable to nano-imprint the photoresist layer by using a prefabricated die with a grating pattern of nanometer size by way of a nano-imprinting process. The die is fabricated in advance according to the grating pattern, composed of parallel slits, required for polarizing light. The regions of the photoresist layer corresponding to the regions other than the black matrix are imprinted with the grating pattern after the photoresist is nano-imprinted. The die may be made of quartz, glass or plastic material.

Step 4, etching the intermediate layer by using the photoresist pattern with a grating pattern of nanometer size as an etching mask to form a black matrix and a polarizing structure of a grating pattern in the intermediate layer as well.

The etching in this step may be a dry etching preferably. A wet etching or other etching method may also be applied in this step.

The resultant black matrix and the polarizing structure are formed on the glass substrate as a base substrate. The polarizing structure comprises a plurality of units which are located in respective pixel regions, which are arranged in an array, spaced from each other, and defined by the black matrix. The main structure parameters of the grating polarizer, i.e., the polarizing structure in the embodiment, comprise grating period, grating duty ratio, and grating depth. The critical parameter to determine the grating performance (TM transmittance and extinction ratio) is the relationship between the grating period and the wavelength of incident light. When the grating period is greater than the wavelength of incident light, the grating produces multiple-stage diffracted waves, and now the grating can be used as a diffraction grating but not a polarizer. When the grating period is much smaller than the wavelength of incident light, the grating only produces zero level diffracted wave, has strong polarization characteristics, with TM polarized light transmitting through and TE polarized light being reflected back, and may act as a polarizer with good performance. In an example, the grating period of grating pattern of the polarizing structure of this embodiment is between 60 nm-300 nm, the grating duty ratio is between 0.3-0.7, preferably is 0.5, and the grating depth is between 100 nm-200 nm, for polarizing the visual light. Thus the polarizing structure formed in the embodiment is capable of polarizing light, which ensures the display including the color filter substrate to function properly.

The method according to the embodiment, before or after step 4, may further comprises:

Step 4′, forming a color filter layer.

If this step is performed before step 4, then the color filter layer, e.g., RGB (red; green; blue) sub-pixels layer is formed on the base substrate, and the black matrix and the polarizing structure are formed on the color filter layer. If this step is performed after step 4, then the black matrix and the polarizing structure are formed on the base substrate, and the color filter layer is formed on the black matrix and the polarizing structure. The RGB sub-pixels correspond to the sub-pixels defined by the black matrix. The formed color filter layer is not limited to such an RGB combination, but may also be for example CMYK (cyan; magenta; yellow; black) combination.

In the case of step 4′ being performed after step 4, further, the color filter layer may be formed with an overcoat layer thereon, and this overcoat layer may be formed of a resin material. The overcoat layer is used to protect the color filter layer having an uneven surface and also used to provide an even upper surface so as to form the other structure layer(s) thereon.

Further, the overcoat layer may be formed with a transparent common electrode layer (e.g., ITO common electrode) thereon. In an application, if the transparent common electrode layer of a liquid crystal display of the mode of fringe-field switching (FFS) or in-plane switching (IPS) is formed on the array substrate, there is no need to form a transparent common electrode layer on the color filter substrate.

On the transparent common electrode layer or the overcoat layer without a transparent common electrode thereon, there may also be formed with post spacers which are used to maintain the space for the injection of liquid crystal after assembling the color filter substrate and the array substrate and keep the gap of the formed panel.

In another example, the spacers may also be located on the overcoat layer, projecting out of the transparent common electrode layer on the overcoat layer. Or the spacers may also be located on the color filter layer, projecting out of the transparent common electrode layer and the overcoat layer on the color filter layer. The spacers may also be located on the base substrate, projecting out of the black matrix or the polarizing structure, and the color filter layer, and further possibly out of the overcoat layer and the transparent common electrode layer, if they are formed.

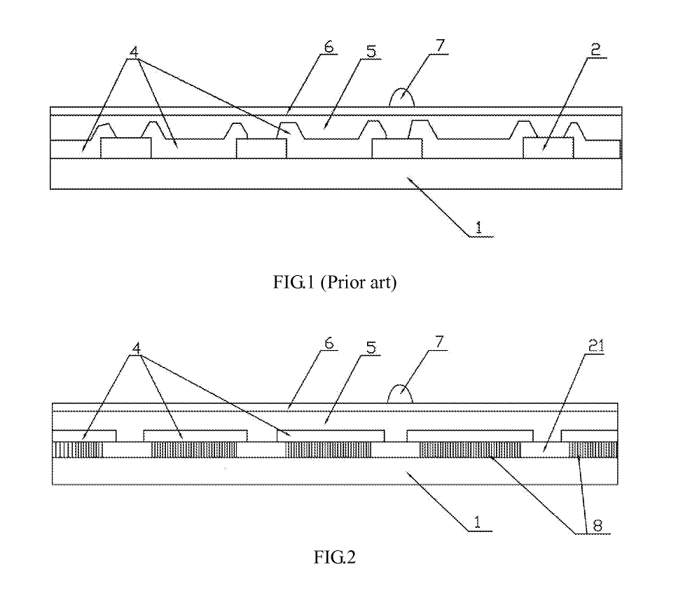

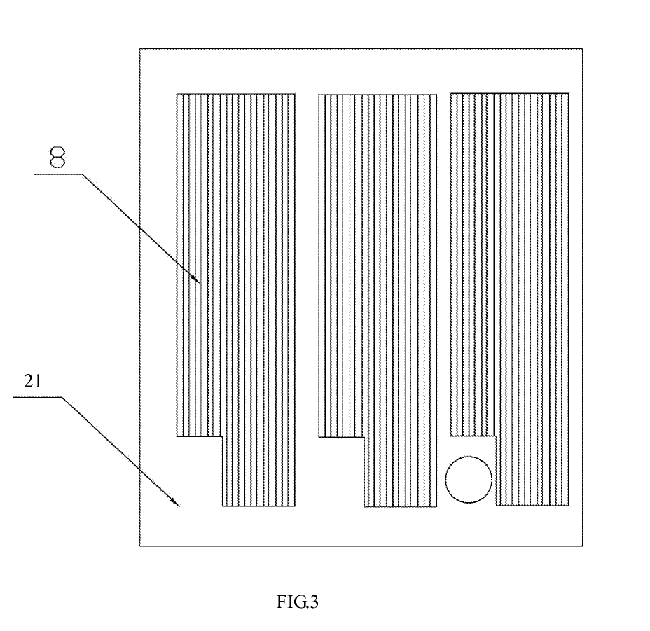

As shown in FIG. 2, a structure schematic view of a color filter substrate capable of polarizing in an embodiment of the disclosure is shown. FIG. 3 is a top view of a black matrix and a polarizing structure in the embodiment of the disclosure. As show in the drawings, a color filter substrate in this embodiment comprises a base substrate 1, a black matrix 21 formed on the base substrate 1, a polarizing structure 8 in the same layer with and preferably formed integrally with the black matrix 21. The polarizing structure 8 is located in the black matrix 2 and comprises a plurality of sub-pixels spaced from each other, and further comprises grating patterns of nanometer size side by side. A color filter layer 4 is formed above or below the black matrix 21 and the polarizing structure8. The color filter layer 4 comprises sub-pixels corresponding to the sub-pixels defined by the black matrix. When the color filter layer 4 is located above the black matrix 21, the color filter layer 4 may be formed with an overcoat layer 5 thereon, and the overcoat layer 5 may be formed with a transparent common electrode layer 6 thereon. There are spacers 7 formed on the base substrate 1, the color filter layer 4, the overcoat layer 5, or the transparent common electrode layer 6.

It can be seen from the above embodiment, the disclosure intends to form a black matrix and at the same time forms a polarizing structure capable of polarizing with an intermediate layer for forming the black matrix, by using photoresist pattern as a mask to etch the underlying intermediate layer (for example a metal layer or a resin layer), and the photoresist pattern is formed with a grating pattern of nanometer size. Consequently, the effect of display can be ensured while the step of attaching polarizer can be omitted, which save the time of process and reduce costs.

The embodiment of the disclosed technology being thus described, it will be obvious that the same may be varied in many ways. Such variations are not to be regarded as a departure from the spirit and scope of the disclosed technology, and all such modifications as would be obvious to those skilled in the art are intended to be comprised within the scope of the following claims.

What is claimed is:

1. A manufacturing method of a color filter substrate comprising:
step 1, forming an intermediate layer containing conductor on a base substrate;
step 2, forming a photoresist layer on the intermediate layer;
step 3, forming the photoresist layer into a photoresist pattern with a grating pattern of nanometer size; and
step 4, using the photoresist pattern with a grating pattern of nanometer size to etch the underlying intermediate layer to form the intermediate layer into a black matrix and a polarizing structure having grating patterns.

2. The manufacturing method of a color filter substrate according to claim 1, wherein the polarizing structure comprises a grating pattern which is constructed of parallel slits, and the grating pattern has a grating period between 60 nm-300 nm, a grating duty ratio between 0.3-0.7, and a grating depth between 100 nm-200 nm.

3. The manufacturing method of a color filter substrate according to claim 2, wherein the grating duty ratio of grating pattern of polarizing structure is 0.5.

4. The manufacturing method of a color filter substrate according to claim 1, wherein the step 3 comprises using a die of grating pattern of nanometer size to nano-imprint the photoresist layer so as to imprint the grating pattern on regions in the photoresist layer corresponding to regions other than the black matrix such that a photoresist pattern is obtained.

5. The manufacturing method of a color filter substrate according to claim 1, wherein the intermediate layer comprises a metal layer, or a resin layer containing conductive materials.

6. The manufacturing method of a color filter substrate according to claim 5, wherein the conductive materials comprise metal wires or metal powders of nanometer size.

7. The manufacturing method of a color filter substrate according to claim 1, wherein before or after the step 4, further comprising:
step 4′, forming a color filter layer.

8. A color filter substrate capable of polarizing comprising:
a base substrate, and
a black matrix formed on the base substrate, and
a polarizing structure on the base substrate in the same layer with the black matrix, where the polarizing structure comprises a plurality of regions spaced from each other and grating patterns of nanometer size side by side.

9. The color filter substrate capable of polarizing according to claim 8, wherein the polarizing structure has a grating pattern which is constructed of parallel slits, and the grating pattern has a grating period between 60 nm-300 nm, a grating duty ratio between 0.3-0.7, and a grating depth between 100 nm-200 nm.

10. The color filter substrate capable of polarizing according to claim 9, wherein the grating duty ratio of grating pattern of polarizing structure is 0.5.

11. The color filter substrate capable of polarizing according to claim 8, wherein materials for forming the black matrix and the polarizing structure comprise a metal material or a resin material containing conductive materials.

12. The color filter substrate capable of polarizing according to claim 11, wherein the conductive materials comprise metal wires or metal powders of nanometer size.

13. The color filter substrate capable of polarizing according to claim 8, further comprising a color filter layer located above or below the black matrix and the polarizing structure.

14. The color filter substrate capable of polarizing according to claim 13, further comprising an overcoat layer formed on the color filter layer.

15. The color filter substrate capable of polarizing according to claim 14, further comprising a transparent common electrode formed on the overcoat layer.
